(19) United States
(12) Patent Application Publication
(10) Pub. No.: US 2023/0326052 A1
(43) Pub. Date: Oct. 12, 2023

(54) ESTIMATION METHOD, ESTIMATION APPARATUS AND PROGRAM

(71) Applicant: NIPPON TELEGRAPH AND TELEPHONE CORPORATION, Tokyo (JP)

(72) Inventors: Takehito MIYAZAWA, Musashino-shi, Tokyo (JP); Takayuki KUROZUMI, Musashino-shi, Tokyo (JP); Hideaki KIMATA, Musashino-shi, Tokyo (JP)

(73) Assignee: NIPPON TELEGRAPH AND TELEPHONE CORPORATION, Tokyo (JP)

(21) Appl. No.: 18/023,670

(22) PCT Filed: Sep. 2, 2020
(86) PCT No.: PCT/JP2020/033176

§ 371 Date: Feb. 27, 2023

(51) Int. Cl. G06T 7/521

(52) U.S. Cl. CPC G06T 7/521; G06T 2207/10028

(57) ABSTRACT

An estimation method is an estimation method executed by an estimation device, and includes a feature estimation step of estimating a feature quantity regarding coordinates of a point cloud, a depth derivation step of deriving a depth vector of the point cloud on the basis of predetermined parameters, a shift amount estimation step of deriving a shift amount of the coordinates of the point cloud on the basis of the feature quality, a shift processing step of shifting the coordinates of the point cloud on the basis of the shift amount and the depth vector, and a plane estimation step of estimating parameters of a plane that fits the coordinates of the point clouds including the point cloud whose coordinates have been shifted.

### TECHNICAL FIELD

The present invention relates to an estimation method, an estimation device, and a program.

### BACKGROUND ART

When a shape of a room (disposition of walls, a floor, a ceiling, a doorway, and the like of the room) is estimated, three-dimensional coordinates of point clouds distributed on a surface of the walls or the like of the room are obtained by a depth sensor scanning the surface of the walls or the like with light rays. A method of assuming that shapes of walls, a floor, a ceiling, and a doorway are planes and executing plane fitting processing with respect to point clouds is known. A disposition of planes obtained as a result of this plane fitting processing represents a disposition of walls having plane shapes, or the like. However, because noise exists in the coordinates of the point clouds obtained by scanning, it is difficult to estimate a plane that perfectly fits all the point clouds through the plane fitting process.

Therefore, in the plane fitting processing, an estimation device estimates a plane with the shortest distance from the point cloud (a plane that fits the point cloud) using a least squares method. However, because the number of point clouds is enormous, the number of times of calculating the distance between the point cloud and the plane is enormous. Further, there may be outliers in the point clouds. Because the point cloud has a large effect on a result of the least squares method, it is desirable to exclude such outliers in advance.

Random sample consensus (RANSAC) is known as a method of solving such a problem (see Non Patent Literature 1). RANSAC is one robust estimation algorithm. In RANSAC, a small number of samples (feature point clouds) are selected from point clouds. An estimation device estimates parameters of each plane representing a wall or the like by executing plane fitting processing with respect to a small number of samples. Because a point cloud with extreme outliers exists in only some of all the point clouds, the outliers are excluded by randomly selecting a small number of samples from the point clouds. Further, in RANSAC, because the least squares method is executed with respect to a small number of samples, an amount of calculation is small.

However, in the plane fitting processing using RANSAC, it is not possible to identify walls, a floor, a ceiling, and a doorway of a room, and furniture and the like disposed in the room. Therefore, when a shape of the room is estimated, a part of a wall or the like of the room may be hidden by furniture and the like, and a depth sensor may not be able to see a part of the room.

On the other hand, a method of identifying a wall or the like and furniture or the like by an RGB (Red, Green, Blue) image of the wall or the like taken by a camera being input to a neural network instead of the coordinates of a point cloud being used is known (see NPL 2). Here, both the coordinates of the point cloud and the RGB image may be input to the neural network.

Because an RGB image contains abundant information useful for identifying furniture and the like, the estimation device can more accurately estimate a shape of a room as compared to a case in which only the coordinates of a point cloud are input to a neural network.

### CITATION LIST

### Non Patent Literature

[NPL 1] Martin A. Fischler & Robert C. Bolles (June 1981). “Random Sample Consensus: A Paradigm for Model Fitting with Applications to Image Analysis and Automated Cartography” (PDF). Comm. ACM. 24 (6): 381-395.

[NPL 2] Chen-Yu Lee, Vijay Badrinarayanan, Tomasz Malisiewicz, Andrew Rabinovich; “RoomNet: End-To-End Room Layout Estimation” The IEEE International Conference on Computer Vision (ICCV), 2017, pp. 4865-4874.

### SUMMARY OF INVENTION

### Technical Problem

However, from the viewpoint of privacy protection, confidentiality, and the like, there are cases in which it is not possible for a camera or a depth sensor to capture an RGB image in a room. Thus, when a part of an estimation target section (indoors) cannot be seen due to disposition of an obstacle in a section, there is a case in which a shape of the section cannot be estimated without using an RGB image.

In view of the above circumstances, an object of the present invention is to provide an estimation method, an estimation device, and a program capable of estimating a shape of a section without using an RGB image when a part of the section cannot be seen due to disposition of an obstacle.

### Solution to Problem

An aspect of the present invention is an estimation method executed by an estimation device, and includes a feature estimation step of estimating a feature quantity regarding coordinates of a point cloud, a depth derivation step of deriving a depth vector of the point cloud on the basis of predetermined parameters, a shift amount estimation step of deriving a shift amount of the coordinates of the point cloud on the basis of the feature quality, a shift processing step of shifting the coordinates of the point cloud on the basis of the shift amount and the depth vector, and a plane estimation step of estimating parameters of a plane on the basis of the point cloud whose coordinates have been shifted.

An aspect of the present invention is an estimation device including: a feature estimation unit configured to estimate a feature quantity regarding coordinates of a point cloud; a depth derivation step unit configured to derive a depth vector of the point cloud on the basis of predetermined parameters; a shift amount estimation unit configured to derive a shift amount of the coordinates of the point cloud on the basis of the feature quality; a shift processing unit configured to shift the coordinates of the point cloud on the basis of the shift amount and the depth vector; and a plane estimation unit configured to estimate parameters of a plane on the basis of the point cloud whose coordinates have been shifted.

An aspect of the present invention is a program for causing a computer to function as the estimation device.

### Advantageous Effects of Invention

According to the present invention, it is possible to estimate a shape of a section without using an RGB image when a part of the section cannot be seen due to disposition of an obstacle.

### BRIEF DESCRIPTION OF DRAWINGS

FIG. 1 is a diagram illustrating a configuration example of an estimation device.

FIG. 2 is a diagram illustrating an example of shift of coordinates of each feature point.

FIG. 3 is a flowchart illustrating an operation example of the estimation device.

FIG. 4 is a diagram illustrating a hardware configuration example of the estimation device.

### DESCRIPTION OF EMBODIMENTS

An embodiment of the present invention will be described in detail with reference to the drawings.

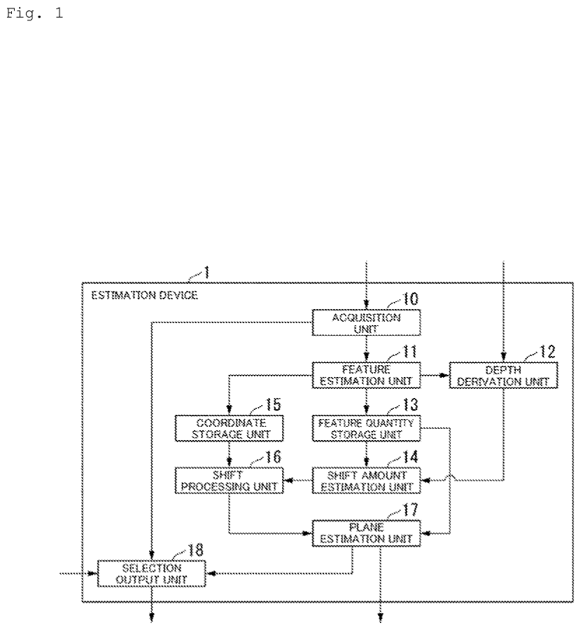

FIG. 1 is a diagram illustrating a configuration example of an estimation device 1. The estimation device 1 is a device that estimates a shape of a section in a real space. For example, the estimation device 1 estimates a shape of a section (indoor) of a room determined by each of dispositions of walls, a floor, a ceiling, doorway, and the like. For example, the estimation device 1 may estimate a shape of an outdoor feature determined by each of dispositions of a building, a road, or the like. Hereinafter, the estimation device 1 estimates a shape of a section (indoor) of a room as an example.

A depth sensor is installed in the section of the room. The depth sensor irradiates walls, a floor, a ceiling, and a doorway of a room with light rays (for example, infrared rays or laser light) while changing a direction of the light rays. That is, the depth sensor scans walls, the floor, the ceiling, and the doorway with the light rays.

Accordingly, the depth sensor generates point cloud data of the section of the room. The point cloud data is three-dimensional coordinates of a point cloud. When the estimation device 1 estimates a shape of the section of the room, the point cloud data may be a depth map.

The depth sensor is not limited to a specific type of sensor as long as the sensor can acquire coordinates of the point cloud. The depth sensor may be, for example, a “kinect (registered trademark)”, a mobile mapping system (MMS), or a smartphone.

Because the light rays emitted from the depth sensor are not blocked by an obstacle (for example, an object such as a person, furniture, and a home appliance) when an obstacle is not disposed in the section of the room, the depth sensor can see each of planes of the wall, the floor, the ceiling, and the doorway. In this case, the point cloud data represents coordinates of the point cloud distributed on each of surfaces of the wall, the floor, the ceiling, and the doorway.

On the other hand, because a part of the light rays emitted from the depth sensor may be blocked by the obstacle when an obstacle is disposed in a section of a room, the depth sensor may not be able see a part of any of the planes of the walls, the floor, the ceiling, and the doorway. In this case, the point cloud data represents coordinates of a point cloud distributed on each of surfaces of the wall, the floor, the ceiling, and the doorway, and coordinates of a point cloud distributed on a surface of the obstacle. Therefore, it is necessary to estimate a shape of the section after the point cloud distributed on the surface of the obstacle is projected onto the plane (the wall, the floor, the ceiling, or the doorway).

The estimation device 1 includes an acquisition unit 10, a feature estimation unit 11, a depth derivation unit 12, a feature quality storage unit 13, a shift amount estimation unit 14, a coordinate storage unit 15, a shift processing unit 16, a plane estimation unit 17, and a selection output unit 18.

The acquisition unit 10 acquires the coordinates of the point cloud (point cloud data) from the depth sensor 20. The acquisition unit 10 may acquire the coordinates of the point cloud from a predetermined storage device.

It is desirable for the number of feature points to be smaller than the number of acquired point clouds from the viewpoint of reduction of the amount of calculation and removal of noise in processing in a stage after the acquisition unit 10. Therefore, the feature estimation unit 11 collects point clouds existing within a certain range from a predetermined sampling point into points. The feature estimation unit 11 outputs a feature point cloud by estimating the collected points as feature points. The feature estimation unit 11 may estimate a feature quality regarding coordinates of the feature point cloud using, for example, a neural network disclosed in Reference 1 (Charles R. Qi, Li Yi, Hao Su, Leonidas J. Guibas; “PointNet++: Deep Hierarchical Feature Learning on Point Sets in a Metric Space” Advances in neural information processing systems. 2017.). The feature estimation unit 11 records coordinates of the selected feature point cloud in the coordinate storage unit 15. The feature estimation unit 11 may output all the point clouds as feature point clouds.

The feature estimation unit 11 estimates the feature quality regarding the coordinates of the feature point cloud. The feature estimation unit 11 records each feature quality in the feature quality storage unit 13.

The feature quality regarding the coordinates of the feature point cloud is not limited to a specific type of feature quality as long as the feature quality is a feature quality regarding the distribution of coordinates. For example, the feature quantities regarding the coordinates of the feature point cloud are dimensions of the obstacle in which the feature point cloud is distributed, a distance between the wall and the obstacle, a surface area of the obstacle, and a curvature of a shape of the obstacle.

For example, because a shape of a handle or the like of the refrigerator has a characteristic curvature, the feature estimation unit 11 can specify that the obstacle disposed in the room is the refrigerator on the basis of a curvature of a distribution of the coordinates. Further, the feature estimation unit 11 can specify a size of the refrigerator and an installation position and orientation of the refrigerator on the basis of the curvature of the distribution of the coordinates. The feature estimation unit 11 can estimate a general distance between the refrigerator and the wall by the feature estimation unit 11 specifying that the obstacle is the refrigerator, and specifying the size of the refrigerator, and the installation position and orientation of the refrigerator.

For example, because a shape of a screen of the liquid crystal display has characteristic dimensions (for example, a ratio of 16:9), the feature estimation unit 11 can specify that the obstacle disposed in the room is the liquid crystal display on the basis of the dimensions of the distribution of the coordinates. Further, the feature estimation unit 11 can specify a size of the liquid crystal display and an installation position and orientation of the liquid crystal display. By the feature estimation unit 11 specifying that the obstacle is a liquid crystal display and specifying the size of the refrigerator, and the installation position and orientation of the liquid crystal display, the feature estimation unit 11 can estimate a general distance between the liquid crystal display and the wall.

The depth derivation unit 12 derives a depth vector of the feature point cloud on the basis of the coordinates of the feature point cloud and camera parameters. The camera parameters represent a position and an orientation of the depth sensor. The depth derivation unit 12 outputs the depth vector having a position of the depth sensor as a start point and a position of the feature point cloud as an end point to the shift amount estimation unit 14. The feature quality storage unit 13 stores the feature quality regarding the coordinates of the feature point cloud.

The shift amount estimation unit 14 derives a shift amount of the coordinates of the feature point cloud on the basis of the depth vector of the feature point cloud and each feature quality. For example, the shift amount estimation unit 14 detects a class of the obstacle according to a result of semantic segmentation based on each feature quality. That is, the shift amount estimation unit 14 derives that the obstacle is, for example, a refrigerator, depending on the result of the semantic segmentation based on each feature quality. The shift amount estimation unit 14 derives the shift amount of the coordinates of the feature point cloud according to a detection result of the class of the obstacle. The coordinate storage unit 15 stores the coordinates of the feature point cloud.

Further, the shift amount estimation unit 14 may derive the shift amount of the coordinates of the feature point cloud using, for example, a neural network disclosed in Reference 2 (Qi, Charles R., et al. “Deep hough voting for 3d object detection in point clouds.” Proceedings of the IEEE International Conference on Computer Vision. 2019.).

The shift processing unit 16 shifts the coordinates of the feature point cloud by the derived shift amount in a direction of the depth vector. That is, the shift processing unit 16 projects a point cloud on the surface of the obstacle onto a plane on the basis of the shift amount and the depth vector.

The plane estimation unit 17 estimates parameters of the plane that fits the coordinates of the point clouds including the point cloud whose coordinates have been shifted. Here, the plane estimation unit 17 executes the plane fitting processing using a predetermined algorithm. The predetermined algorithm is, for example, RANSAC. The plane estimation unit 17 may execute plane fitting processing using a deep learning network of a differentiable RANSAC disclosed in Reference 3 (Brachmann, Eric, et al. “Dsac-differentiable ransac for camera localization.” Proceedings of the IEEE Conference on Computer Vision and Pattern Recognition. 2017.). The plane estimation unit 17 learns all of processing including the plane fitting processing by using the deep learning network of the differentiable RANSAC. Accordingly, because the plane fitting processing optimized for the output of the shift processing unit 16 is executed, improvement in the estimation accuracy of the parameters of the plane can be expected.

The coordinates of the feature point cloud include coordinates of the wall or the like, and coordinates of the obstacle before the coordinates are shifted. Therefore, it is possible to accurately estimate the parameters of the plane by using not only the coordinates of the feature point cloud, but also the feature quantity regarding the coordinates of the feature point cloud.

The selection output unit 18 acquires a selection signal according to an operation of the user. The selection output unit 18 outputs computer graphics representing the shape of the section (indoor) of the room in three dimensions to a predetermined display unit in response to a selection signal based on an operation of the user.

When the selection signal indicates that the shape of the room is displayed, the selection output unit 18 outputs the coordinates of the point cloud along the plane (fitted plane) from which the parameters have been estimated, to the display unit. When the selection signal indicates that the shape of the room, furniture, and the like is displayed, the selection output unit 18 outputs both the coordinates of the point cloud along the plane from which the parameters have been estimated and the coordinates of the point cloud along the surface of the obstacle to the display unit.

Next, an example of shift of coordinates of each feature point will be described.

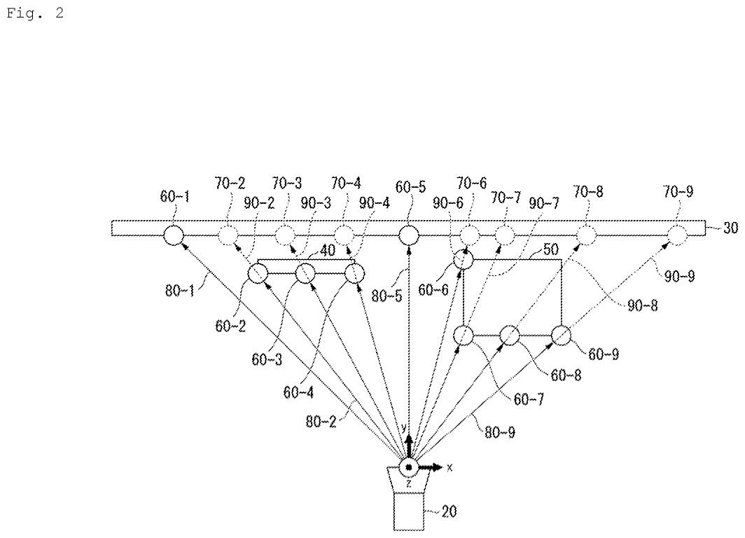

FIG. 2 is a diagram (a bird's-eye view of a room) illustrating an example of shift of coordinates of each feature point. A plane plate 30 is, for example, a plane of a wall, a floor, a ceiling, a doorway, or the like. Disposition of the plane plate 30 determines a shape of a section (indoor) of a room. In FIG. 2, an obstacle 40 and an obstacle 50 are disposed in the section of the room. The obstacle 40 is, for example, a liquid crystal display. The obstacle 50 is, for example, a refrigerator.

The point cloud data is generated by the depth sensor 20 with a single viewpoint. Hereinafter, the point cloud data is three-dimensional coordinates (x, y, z) of the feature point cloud. As described above, the point cloud data may not include a reflection intensity value of the light rays.

The depth sensor 20 irradiates the plane plate 30, the obstacle 40, and the obstacle 50 with the light rays while changing an irradiation direction of the light rays. Accordingly, the depth sensor 20 generates point cloud data (coordinates of the point cloud) of the section of the room. In FIG. 2, the feature estimation unit 11 selects each feature point 60 from the point cloud.

In FIG. 2, a feature point 60-1 and a feature point 60-5 are in a point cloud along the plane plate 30. A feature point 60-2, a feature point 60-3, and a feature point 60-4 are in a point cloud along the surface of the obstacle 40. A feature point 60-6, a feature point 60-7, a feature point 60-8, and a feature point 60-9 are in a point cloud along the surface of the obstacle 50.

A depth vector 80 is a vector having the depth sensor 20 as a start point and the feature point 60 as an end point. A direction of a shift vector 90-n (n is an integer equal to or larger than 1) is the same as a direction of a depth vector 80-n. A length of the shift vector 90 represents a shift amount of the coordinates of the feature point 60.

The length of any one of the plurality of shift vectors 90 may be 0. For example, because the coordinates of the feature point 60-1, which is in a point cloud along the plane plate 30, are not shifted, a length of a shift vector of the feature point 60-1 is 0.

A correlation between the feature quality based on the coordinates of the feature point cloud and the shift amount is learned in advance using a machine learning scheme in a learning stage. For example, a learned model executes machine learning with the feature quality based on the coordinates of the feature point cloud as an input and the shift amount as an output. The learned model includes, for example, a neural network. In an estimation stage after the learning stage, the shift amount estimation unit 14 derives the shift amount for each feature point using the learned model.

Coordinates of a feature point 60-n are shifted on the basis of the shift vector 90-n. That is, coordinates of the feature point 60-n are shifted in the direction of the depth vector by the shift amount derived by the shift amount estimation unit 14.

When the feature point 60 is located at a position of the plane plate 30 (wall or the like) constituting the shape of the section (indoor), the shift amount is 0. On the other hand, when the feature point 60 is located on the surface of the obstacle (refrigerator or the like) disposed in the section, the shift amount is a distance from the feature point to the plane plate 30 in the direction of the depth vector (shift vector) of the feature point.

A type of obstacle (home appliances, or the like) can be estimated on the basis of the coordinates of the feature point cloud (a distribution shape of the feature point cloud). A general dimension of the obstacle, or the like can be estimated according to a type of the obstacle. Therefore, the shift amount can be estimated on the basis of a general distance between the plane plate 30 (wall or the like) existing on an extension line of the depth vector 80 and the obstacle. For example, when the obstacle is a liquid crystal display, the obstacle is often disposed at a position close to a wall, and thus, the shift amount is estimated to be, for example, a distance of 1 m or less.

In FIG. 2, the feature point 60-2, the feature point 60-3, and the feature point 60-4 along the surface of the obstacle 40 are projected onto the plane plate 30. The feature point 60-6, the feature point 60-7, the feature point 60-8, and the feature point 60-9 along the surface of the obstacle 50 are projected onto the plane plate 30. Thus, the coordinates of the feature point 60-n are shifted to coordinates of the feature point 70-n along the surface of the plane plate 30.

The shift amount of the coordinates of the feature point cloud of the plane plate 30 is 0. As the plane fitting processing, the plane estimation unit 17 estimates the parameters of the plane that fits the feature point cloud including the feature point cloud whose coordinates have been shifted. That is, the plane estimation unit 17 estimates the parameters of the plane that fits the coordinates of the feature point cloud not shifted from the plane plate 30 and the coordinates of the feature point cloud shifted from the surface of each obstacle.

In FIG. 2, the plane estimation unit 17 executes the plane fitting processing with respect to each of coordinates of the feature point 60-1, feature points 70-2 to 70-4, the feature points 60-5, and feature points 70-6 to 70-9. Accordingly, the plane estimation unit 17 derives the parameters of the plane representing the disposition of the plane plate 30. The plane estimation unit 17 outputs the parameters of plane to, for example, the display unit.

Next, an operation example of the estimation device 1 will be described.

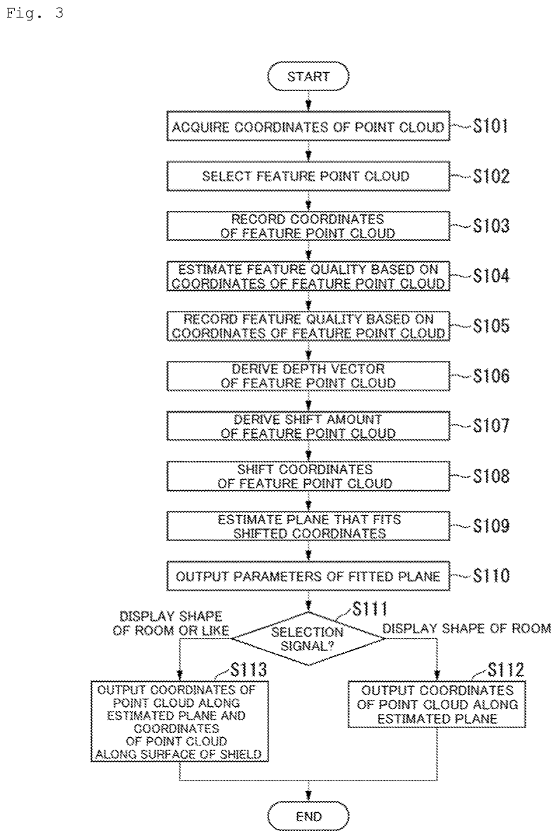

FIG. 3 is a flowchart illustrating an operation example of the estimation device 1. The acquisition unit 10 acquires the coordinates of the point cloud (point cloud data) from the depth sensor 20 (step S101). The feature estimation unit 11 selects the feature point cloud from the point cloud (step S102). The feature estimation unit 11 records the coordinates of the selected feature point cloud in the coordinate storage unit 15 (step S103).

The feature estimation unit 11 estimates one or more feature quantities on the basis of the coordinates of the feature point cloud (step S104). The feature estimation unit 11 records each feature quality in the feature quality storage unit 13 (step S105). The depth derivation unit 12 derives the depth vector of the feature point cloud on the basis of the coordinates of the feature point cloud and the camera parameters (step S106).

The shift amount estimation unit 14 derives the shift amount of the coordinates of the feature point cloud on the basis of the depth vector of the feature point cloud and each feature quality (step S107).

The shift processing unit 16 shifts the coordinates of the feature point cloud (projects the coordinates of the feature point cloud onto a predetermined plane) by the derived shift amount in the direction of the depth vector (step S108). The plane estimation unit 17 estimates the parameters of the plane that fits the feature point clouds including the feature point cloud whose coordinates have been shifted (step S109). The plane estimation unit 17 outputs the parameters of the fitted plane to, for example, the display unit (step S110).

The selection output unit 18 acquires the selection signal (step S111). When the selection signal indicates that the shape of the room is displayed (step S111: the shape of the room is displayed), the selection output unit 18 outputs the coordinates of the point cloud along the fitted plane estimated on the basis of the point cloud projected onto the predetermined plane and a point cloud of the wall or the like (step S112). When the selection signal indicates that the shape of the room, the furniture, and the like are displayed (step S111: the shape of the room and the like is displayed), the selection output unit 18 outputs the coordinates of the point cloud along the estimated fitted plane and the coordinates of the point cloud along the surface of the obstacle (step S113).

As described above, the depth sensor 20 irradiates a predetermined section with the light rays while changing an irradiation direction of the light rays. The depth sensor 20 generates point cloud data (three-dimensional coordinates of the point cloud) of the predetermined section. The acquisition unit 10 acquires the coordinates of the point cloud using the depth sensor 20.

The feature estimation unit 11 estimates the feature quality regarding the coordinates of the point cloud. The depth derivation unit 12 derives the depth vector of the point cloud on the basis of a predetermined parameter (for example, the camera parameters of the depth sensor 20). The shift amount estimation unit 14 derives the shift amount of the coordinates of the point cloud on the basis of the feature quality. The shift processing unit 16 shifts the coordinates of the point cloud on the basis of the shift amount and the depth vector. That is, the shift processing unit 16 projects the point cloud on the surface of the obstacle onto the predetermined plane on the basis of the shift amount and the depth vector. The plane estimation unit 17 estimates the parameters of the plane on the basis of the point cloud whose coordinates have been shifted. That is, the plane estimation unit 17 estimates the parameters of the plane that fits the coordinates of the point clouds including the point cloud whose coordinates have been shifted.

This makes it possible to estimate the shape of the section without using an RGB image even when it is not possible to see a part of the section (occlusion occurs) because the obstacle is disposed.

When the point cloud data is generated by the depth sensor 20 with a plurality of viewpoints, the plane estimation unit 17 merges results of the plane fitting of the plurality of viewpoints (estimation results of the plane for each viewpoint) to estimate the parameters of the plane that fits the coordinates of the feature point cloud. This makes it possible to improve estimation accuracy of the shape of the section.

### Modification Example

Points of estimation target data for improving the estimation accuracy of the parameters of the plane is supplemented. In order to improve the estimation accuracy of the parameters of the plane, the depth sensor and the acquisition unit 10 acquire the point cloud so that a ratio of the point cloud regarding the ceiling, the wall, and the floor is high.

When there is no restriction that the depth sensor acquires the point cloud in one shot, for example, the depth sensor acquires the point cloud from a shooting position (scanning position) at which a ratio regarding the ceiling, wall, and floor increases. Further, a shooting position of the depth sensor may be moved for each shot so that the ratio regarding the ceiling, wall, and floor increases.

When there is the restriction that the depth sensor acquires the point cloud in one shot, the depth sensor may face a corner of the room and acquire a point cloud. For example, the depth sensor may face two walls constituting the corner of the room and acquire a point cloud in one shot. Accordingly, because at least the point cloud regarding the two walls constituting the corner of the room is acquired, it is possible to increase a ratio of the point cloud regarding the wall. Further, for example, the depth sensor may face at least one of the two walls constituting the corner of the room, a ceiling, and a floor, and acquire the point cloud in one shot.

Next, a hardware configuration example of the estimation device 1 will be described.

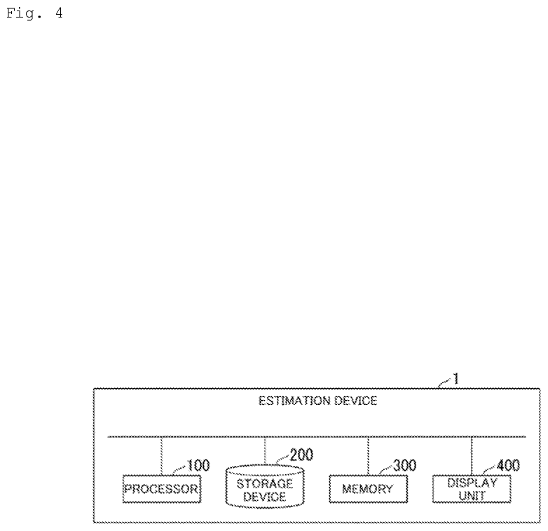

FIG. 4 is a diagram illustrating a hardware configuration example of the estimation device 1. Some or all of functional units of the estimation device 1 is realized as software by a processor 100 such as a central processing unit (CPU) executing a program stored in a storage device 200 having a nonvolatile recording medium (non-transitory recording medium) and a memory 300. The program may be recorded in a computer-readable recording medium. The computer-readable recording medium is, for example, a portable medium such as a flexible disk, a magneto-optical disk, a read only memory (ROM), or a compact disc read only memory (CD-ROM), or a non-transitory storage medium such as a storage device such as a hard disk drive built into a computer system. The display unit 400 displays, for example, coordinate information of the point cloud, coordinate information of the feature point cloud, and a three-dimensional image representing the shape of the section (indoor) of the room.

Some or all of functional units of the estimation device 1 may be realized, for example, by using hardware including an electronic circuit (or circuitry) using a large scale integration circuit (LSI), an application specific integrated circuit (ASIC), a programmable logic device (PLD), a field programmable gate array (FPGA), or the like.

Although the embodiments of the present invention have been described above in detail with reference to the drawings, a specific configuration is not limited to the embodiments, and includes designs and the like in a range not departing from the gist of the present invention.

### Industrial Applicability

The present invention is applicable to a device that estimates a shape of a section such as a room including a wall, a floor, a ceiling, and a doorway.

### Reference Signs List

1: Estimation device

10: Acquisition unit

11: Feature estimation unit

12: Depth derivation unit

13: Feature quality storage unit

14: Shift amount estimation unit

15: Coordinate storage unit

16: Shift processing unit

17: Plane estimation unit

18: Selection output unit

20: Depth sensor

30: Plane plate

40: Obstacle

50: Obstacle

60: Feature point

70: Feature point

80: Depth vector

90: Shift vector

1. An estimation method executed by an estimation device, the estimation method comprising:
a feature estimation step of estimating a feature quantity regarding coordinates of a point cloud;
a depth derivation step of deriving a depth vector of the point cloud on the basis of predetermined parameters;
a shift amount estimation step of deriving a shift amount of the coordinates of the point cloud on the basis of the feature quality;
a shift processing step of shifting the coordinates of the point cloud on the basis of the shift amount and the depth vector; and
a plane estimation step of estimating parameters of a plane on the basis of the point cloud whose coordinates have been shifted.

2. The estimation method according to claim 1, further comprising an acquisition step of acquiring the coordinates of the point cloud using a sensor; and
a selection output step of outputting coordinates of a point cloud along a wall, a floor, a ceiling, or a doorway of a room, or coordinates of a point cloud along the wall, the floor, the ceiling, or the doorway of the room and a surface of an obstacle according to a selection signal.

3. The estimation method according to claim 2, wherein the obstacle is at least one of furniture, a home appliance, and a person.

4. The estimation method according to claim 2, wherein the shift processing step includes projecting coordinates of a point cloud along the surface of the obstacle onto a predetermined plane, and
the plane estimation step includes estimating the parameters of the plane that fits the coordinates of the point cloud along the wall, the floor, the ceiling, or the doorway of the room and the coordinates of the point cloud projected onto the predetermined plane.

5. An estimation device comprising:
a processor; and
a storage medium having computer program instructions stored thereon, when executed by the processor, perform to:
estimate a feature quantity regarding coordinates of a point cloud;
derive a depth vector of the point cloud on the basis of predetermined parameters;
derive a shift amount of the coordinates of the point cloud on the basis of the feature quality;
shift the coordinates of the point cloud on the basis of the shift amount and the depth vector; and
estimate parameters of a plane on the basis of the point cloud whose coordinates have been shifted.

6. A non-transitory computer-readable medium having computer-executable instructions that, upon execution of the instructions by a processor of a computer, cause the computer to function as the estimation device according to claim 5.
